(19) United States
(12) Patent Application Publication
(10) Pub. No.: US 2025/0071530 A1
(43) Pub. Date: Feb. 27, 2025

(54) COMMUNICATION DEVICE, CONTROL METHOD THEREFOR, AND CONTROL METHOD OF COMMUNICATION SYSTEM

(71) Applicant: CANON KABUSHIKI KAISHA, Tokyo (JP)

(72) Inventor: ATSUSHI MINAKAWA, Kanagawa (JP)

(21) Appl. No.: 18/942,060

(22) Filed: Nov. 8, 2024

Related U.S. Application Data
(63) Continuation of application No. PCT/JP2023/010536, filed on Mar. 17, 2023.

(30) Foreign Application Priority Data
May 10, 2022 (JP) 2022-077692

(51) Int. Cl. H04W 4/50; H04W 36/08

(52) U.S. Cl. CPC H04W 4/50; H04W 36/087

(57) ABSTRACT

A communication device comprises: at least one memory that stores a set of instructions; and at least one processor that executes the instructions. The instructions, when executed, causing the communication device to perform operations comprising: receiving, from another communication device by wireless communication, a setting request to request provision of a communication parameter used for connection to a wireless network; deciding priorities for respective communication parameters to be provided to the other communication device; and transmitting, to the other communication device based on the decided priorities, a setting response to the setting request. The transmitted setting response includes the communication parameters in a form in which upon receiving the setting response, the other communication device can specify the priorities for the respective communication parameters.

### CROSS-REFERENCE TO RELATED APPLICATIONS

This application is a Continuation of International Patent Application No. PCT/JP2023/010536, filed Mar. 17, 2023, which claims the benefit of Japanese Patent Application No. 2022-077692 filed May 10, 2022, both of which are hereby incorporated by reference herein in their entirety.

### BACKGROUND OF THE INVENTION

### Field of the Invention

The present invention relates to communication parameter setting processing.

### Background Art

Recently, the Wi-Fi® Device Provisioning Protocol (DPP) standard has been formulated as a technique of setting a communication parameter used to access a wireless network. In the DPP standard, a device called a configurator should provide a communication parameter to a device called an enrollee (US-2017-0295448).

In the DPP standard, the communication parameter is included in a DPP_Configuration_Response frame and transmitted from the configurator to the enrollee. When operating as, for example, an access point (AP), the enrollee to which the communication parameter is provided forms a wireless network based on the obtained communication parameter. Also, when operating as a station (STA), the enrollee is connected to a wireless network based on the obtained communication parameter. In the DPP standard of version 2.0 or subsequent version, not only one communication parameter but also a plurality of communication parameters can be included in a DPP_Configuration_Response frame.

However, if the configurator transmits a plurality of communication parameters, the enrollee does not know which one of the plurality of communication parameters should preferably be used. For this reason, the enrollee tries connection to a network (that is, makes a plurality of trials) sequentially using the plurality of communication parameters. As a result, time is needed until the device is connected to the network, and the convenience of the user may be impaired.

### SUMMARY OF THE INVENTION

According to one aspect of the present invention, a communication device comprises: at least one memory that stores a set of instructions; and at least one processor that executes the instructions, the instructions, when executed, causing the communication device to perform operations comprising: receiving, from another communication device by wireless communication, a setting request to request provision of a communication parameter used for connection to a wireless network; deciding priorities for respective communication parameters to be provided to the other communication device; and transmitting, to the other communication device based on the decided priorities, a setting response to the setting request, wherein the transmitted setting response includes the communication parameters in a form in which upon receiving the setting response, the other communication device can specify the priorities for the respective communication parameters.

Further features of the present invention will become apparent from the following description of exemplary embodiments with reference to the attached drawings.

### BRIEF DESCRIPTION OF THE DRAWINGS

The accompanying drawings, which are incorporated in and constitute a part of the specification, illustrate embodiments of the invention and, together with the description, serve to explain principles of the invention.

FIG. 1 is a view showing the overall configuration of a communication system;

FIG. 2 is a block diagram showing the hardware configuration of a communication device;

FIG. 3 is a flowchart of processing executed by a communication device (configurator);

FIG. 4 is a flowchart of processing executed by a communication device (enrollee);

FIG. 5 is a sequence chart between the communication device (configurator) and the communication device (enrollee);

FIG. 6 is a flowchart of processing executed by a communication device (configurator); and

FIG. 7 is a view showing an example of a notification format.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### First Embodiment

As the first embodiment of a communication device according to the present invention, a communication system including a communication device configured to operate based on the Wi-Fi Device Provisioning Protocol (DPP) standard will be described below as an example. In particular, it is assumed that each communication device is configured to comply with the DPP standard of version 2.0 or subsequent version and transmit/receive a plurality of communication parameters by one DPP_Configuration_Response frame.

### <System Configuration and Device Configuration>

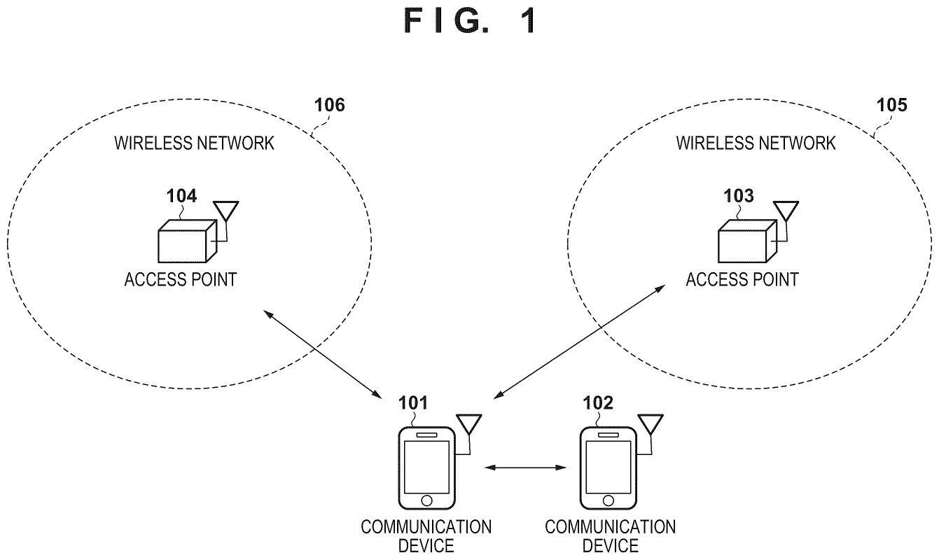

FIG. 1 is a view showing the overall configuration of the communication system. The communication system includes a communication device 101 and a communication device 102.

The communication device 101 operates as a configurator complying with the DPP standard. The configurator is a device whose role is to provide/transmit a communication parameter necessary to connect to or form a wireless network 105 or a wireless network 106. Here, the communication device 101 is assumed to provide the communication parameters of both the wireless networks 105 and 106 to the communication device 102. Note that a plurality of communication parameters are not limited to two communication parameters for connecting to the wireless networks 105 and 106, but may also be three or more communication parameters linked to other wireless networks.

Note that the communication parameter is, for example, a credential complying with the DPP standard, and includes information such as netAccessKey that is key information necessary for connecting to the wireless network 105 or 106. However, the communication parameter is not limited to this and may include information such as Pre Shared Key (PSK) as key information. Also, the communication parameter may include Service Set Identification (SSID) serving as the identifier of the wireless network 105 or 106, or information of the frequency channel. Further, the communication parameter may include information such as a cryptographic method or an authentication method used in the wireless network 105 or 106, or may include the expiration date of the communication parameter.

When the communication device 101 serving as a configurator holds a plurality of communication parameters to be provided to the communication device 102, it decides the priorities of the respective communication parameters so as to cope with the priority of a wireless network to which the communication device 102 is connected. For example, when connecting the communication device 102 to the wireless network 105 in comparison the wireless network 106, the communication device 101 decides the priorities of the respective communication parameters so that the priority of a communication parameter for connecting to the wireless network 105 becomes higher than that of a communication parameter for connecting to the wireless network 106.

When providing a plurality of communication parameters to the communication device 102, the communication device 101 serving as a configurator notifies the communication device 102 of information by which the communication device 102 can specify the priorities of the respective communication parameters. For example, together with the plurality of communication parameters, the communication device 101 provides information representing the priorities of the respective communication parameters. Instead of transmitting together information representing priorities, the communication device 101 may arrange the communication parameters in descending order of priority and transmit them so that the enrollee can specify the priorities of the respective communication parameters.

The communication device 102 operates as an enrollee complying with the DPP standard. The enrollee is a device whose role is to obtain/receive communication parameters necessary to connect to the wireless networks 105 and 106. Here, the communication device 102 is assumed to receive the communication parameters of both the wireless networks 105 and 106 from the communication device 101. The communication device 101 can operate as even a station (STA) that is a slave station connected to the wireless network 105 formed by an access point 103 or the wireless network 106 formed by an access point 104. Note that the communication device 102 may also operate as an access point (AP) that is a wireless base station (master station) configured to form a wireless network.

When requesting a communication parameter, the communication device 102 serving as an enrollee announces even role information. The role information represents a role after performing communication parameter setting processing (to be also referred to as sharing processing). Here, the role represents a “station” that performs wireless network connection using an obtained communication parameter, or an “access point” that performs wireless network formation using an obtained communication parameter. As the role, a “configurator” that provides a communication parameter may be represented. In this case, the communication device 102 operates as a station and thus announces role information representing a “station”.

Note that examples of the communication devices 101 and 102 are an access point device, a mobile phone, a digital camera, a video camera, a printer, a projector, a PC, a PDA, a smartphone, and a smartwatch, but the communication devices 101 and 102 are not limited to them.

The access point 103 operates as, for example, an access point defined by the DPP standard. More specifically, the access point 103 periodically transmits a beacon including information of the wireless network 105, accepts a connection request from another communication device, and permits connection of the other communication device to the wireless network 105. In addition, the access point 103 operates as an enrollee defined by the DPP standard, and can form the wireless network 105 by obtaining a communication parameter from the communication device 101 operating as a configurator. Note that the communication parameter may be not one provided from the configurator, but one set by a user via a user interface (UI).

Similar to the access point 103, the access point 104 can form the wireless network 106 by obtaining a communication parameter from the communication device 101.

The access points 103 and 104 in this embodiment may be electronic devices (for example, a printer and a digital camera) that operate as access points defined by the DPP standard and have a specific function.

The wireless network 105 is a wireless network complying with the IEEE 802.11 series standard and is a network formed by the access point 103. Here, IEEE stands for The Institute of Electrical and Electronics Engineers. However, the wireless network 105 may be a network formed as a Group Owner complying with the Wi-Fi Direct standard. Alternatively, the wireless network 105 may be a network complying with a wireless USB, MBOA, Bluetooth®, UWB, ZigBee, NFC, or the like. Here, MBOA stands for Multi Band OFDM Alliance, and UWB stands for Ultra Wide Band. UWB includes a wireless USB, wireless 1394, and WINET.

Similar to the wireless network 105, the wireless network 106 is a wireless network complying with the IEEE 802.11 series standard and is a network formed by the access point 104.

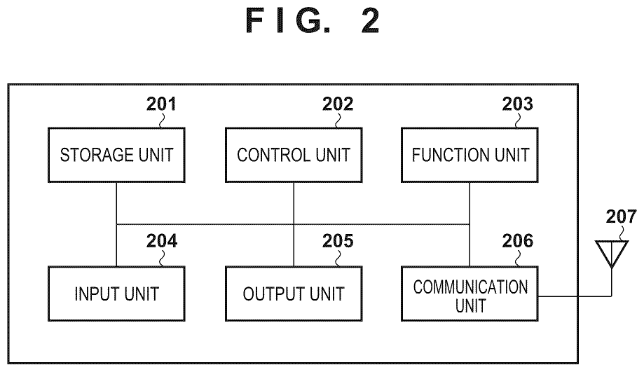

FIG. 2 is a block diagram showing the hardware configuration of the communication device 101. Note that the communication device 102 also has a similar hardware configuration.

A storage unit 201 is constituted by one or more memories such as a ROM and a RAM, and stores various kinds of information such as programs for performing various operations to be described later, and communication parameters for wireless communication. Note that as the storage unit 201, a storage medium such as a flexible disk, a hard disk, an optical disk, a magneto-optical disk, a CD-ROM, a CD-R, a magnetic tape, a nonvolatile memory card, or a DVD may be used in addition to memories such as a ROM and a RAM.

A control unit 202 is constituted by one or more processors such as a CPU and a MPU, and controls the overall communication device 101 by executing a program stored in the storage unit 201. Note that the control unit 202 may control the overall communication device 101 in cooperation with a program and an Operating System (OS) stored in the storage unit 201. It is also possible that the control unit 202 includes a plurality of processors such as a multicore and these processors control the overall communication device 101. The control unit 202 controls a function unit 203 to execute predetermined processing such as image capturing, printing, or projection.

The function unit 203 is hardware for executing predetermined processing by the communication device 101. For example, when the communication device 101 is a camera, the function unit 203 is an image capturing unit and performs image capturing processing. For example, when the communication device 101 is a printer, the function unit 203 is a printing unit and performs printing processing. For example, when the communication device 101 is a projector, the function unit 203 is a projection unit and performs projection processing. Data to be processed by the function unit 203 may be data stored in the storage unit 201 or data communicated with another communication device via a communication unit 206 (to be described later).

An input unit 204 accepts various operations from a user. An output unit 205 performs various outputs to the user. Here, output by the output unit 205 includes at least one of display on the screen, audio output by a loudspeaker, vibration output, and the like. Note that both the input unit 204 and the output unit 205 may be implemented by one module, like a touch panel. The output unit 205 displays given information (for example, public key) as a QR Code® on the screen.

The communication unit 206 controls wireless communication complying with the IEEE 802.11 series standard or controls Internet Protocol (IP) communication. Also, the communication unit 206 controls an antenna 207 to transmit/receive a radio signal for wireless communication. The communication device 101 communicates contents such as image data, document data, or video data with the communication device 102 via the communication unit 206.

### <Operation of Device>

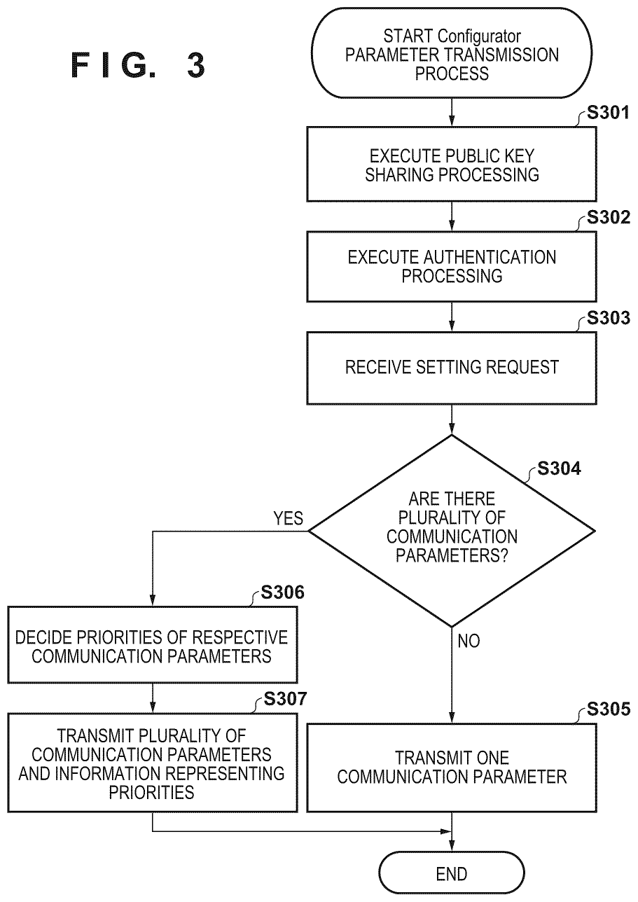

FIG. 3 is a flowchart of processing executed by the communication device 101 serving as a configurator. FIG. 3 shows a flowchart of the sequence of processing implemented by, in a case where the communication device 101 is turned on, reading out a program stored in the storage unit 201 by the control unit 202 and executing it. The processing may be implemented in a case where the communication device 101 enters a predetermined operation mode such as a communication setting mode by a user operation or the like, or a case where a predetermined application such as a communication setting application is activated, instead of the case where the communication device 101 is turned on.

At least part of the flowchart shown in FIG. 3 may be implemented by hardware. When at least part of the flowchart is implemented by hardware, for example, a predetermined compiler may be used to automatically generate a dedicated circuit on a FPGA from a program for implementing each step. FPGA stands for Field Programmable Gate Array. Similar to the FPGA, a gate array circuit may be formed and implemented as hardware. Alternatively, at least part of the flowchart shown in FIG. 3 may be implemented by an Application Specific Integrated Circuit (ASIC). In this case, each block in the following flowchart can be regarded as a hardware block. Note that a plurality of blocks may be combined and constituted as one hardware block, or one block may be constituted as a plurality of hardware blocks.

In step S301, the communication device 101 performs sharing processing of an authentication public key (for example, a bootstrapping key defined by the DPP standard). Here, it is assumed that the communication device 102 displays, on the output unit 205, a QR code including the authentication public key, and the communication device 101 captures an image of the QR code, thereby sharing the authentication public key. However, the processing is not limited to the form in which the communication device 102 displays a QR code on the display or the like.

In step S302, the communication device 101 performs authentication processing using the authentication public key of the communication device 102 obtained in step S301. To perform authentication processing, the communication device 101 transmits an authentication request. The “authentication request” is a DPP_Authentication_Request frame complying with the DPP standard. The authentication request includes authentication information used in authentication processing, identification information of the communication device 101, a random number generated by the communication device 101, and a public key (public key of the communication device 101) for shared key generation used to generate a shared key. The “authentication information” is, for example, the hash value of the authentication public key of the communication device 102 included in the QR code. The identification information of the communication device 101 is, for example, the hash value of the authentication public key of the communication device 101. The random number is used for authentication at the time of receiving an authentication response (to be described later).

Note that the public key (public key of the communication device 101) for shared key generation is used as a key serving as the generation source of a shared key generated between the communication devices 101 and 102. The shared key is generated based on, for example, the Elliptic Curve Diffie-Hellman (ECDH) method. Note that the shared key generation method is not limited to the ECDH method and may be another public key cryptographic method.

Upon receiving the authentication request, the communication device 102 performs verification processing of a device that has transmitted the authentication request. This determination is performed using authentication information included in the authentication request. That is, the communication device 102 calculates the hash value of the authentication public key of the communication device 102, compares the calculated hash value with the hash value (authentication information) included in the authentication request, and if these hash values coincide with each other, determines that the verification is successful. Note that a hash function used to calculate a hash value at this time is defined in the DPP standard and is the same as a hash function used in the communication device 101 to calculate a hash value.

Upon transmitting the authentication request, the communication device 101 waits for an authentication response. The “authentication response” is a DPP_Authentication_Response frame complying with the DPP standard. The authentication response includes the public key of the communication device 102 for shared key generation, a random number generated by the communication device 102, and tag information. Note that the tag information is obtained by encrypting, by the above-described shared key, the hash value that uses the random number or the like included in the authentication request transmitted from the communication device 101. Note that in step S302, if no authentication response is received within a predetermined time after the start of waiting for an authentication response, communication parameter setting processing may end.

If an authentication response is received within the predetermined time, the communication device 101 authenticates the communication device 102 based on information included in the authentication response. More specifically, first, the communication device 101 generates a shared key using the private key of the communication device 101 for shared key generation and the public key of the communication device 102 for shared key generation. The public key of the communication device 101 for shared key generation is a public key of the communication device 101 that corresponds to a private key of the communication device 101 for shared key generation used when the communication device 101 generates a shared key. The public key of the communication device 102 for shared key generation is a public key that corresponds to a private key of the communication device 102 for shared key generation used when the communication device 102 generates a shared key. By using such a combination of keys, the communication device 101 can generate the same shared key as the shared key generated by the communication device 102. Note that if the public keys of the communication devices 101 and 102 for shared key generation cannot be correctly exchanged between the communication devices 101 and 102 by transmitting/receiving the above-mentioned authentication request and authentication response, the same shared key cannot be generated.

Then, the communication device 101 decrypts, by the generated shared key, tag information included in the authentication response, and confirms whether the random number and the like included in the authentication request have correctly been decrypted. If the random number and the like have correctly been decrypted, the communication device 101 determines that the authentication is successful, and qualifies the communication device 102 as an enrollee. To the contrary, if the random number and the like have not correctly been decrypted, the communication device 101 determines that the authentication fails. Note that the case where the random number and the like have not correctly been decrypted is, for example, a case where the same shared key has not been generated. If the authentication fails, the communication device 102 announces an error. If the authentication is successful, the communication device 101 transmits an authentication confirmation to the communication device 102. The “authentication confirmation” is a DPP_Authentication_Confirm frame complying with the DPP standard, and includes tag information. The tag information is obtained by encrypting, by the communication device 101 using the shared key, the random number included in the authentication response transmitted from the communication device 102.

In step S303, the communication device 101 waits for a setting request from the communication device 102, and receives the setting request transmitted from the communication device 102. Note that the time during which a setting request is awaited may be a predetermined time after transmitting an authentication confirmation, or a predetermined time after the image capturing unit is activated in step S301. The “setting request” is a DPP_Configuration_Request frame complying with the DPP standard. The setting request includes device information and role information of the communication device 102. The device information is the device name of the communication device 102 or the like. The role information is information representing a role after receiving a communication parameter, and is “station”, “access point”, or “configurator”. Here, the role information represents “station”. Note that information included in the setting request is encrypted by a shared key used to encrypt tag information when the communication device 102 transmits an authentication response.

In step S304, the communication device 101 determines whether there are a plurality of communication parameters that can be provided. That is, the communication device 101 determines whether there are a plurality of communication parameters by which the communication device 102 operates as a station. If the communication device 101 determines that there are no plurality of communication parameters (there is only one communication parameter) (NO in step S304), the process advances to step S305. If the communication device 101 determines that there are a plurality of communication parameters (YES in step S304), the process advances to step S306. Note that if there is no communication parameter that can be provided, communication parameter setting processing ends.

In step S305, the communication device 101 transmits, to the communication device 102 serving as an enrollee, a setting response including one held communication parameter. The “setting response” is a DPP_Configuration_Response frame complying with the DPP standard. The setting response transmitted from the communication device 101 includes a communication parameter, the expiration date of the communication parameter, the configurator-dedicated public key of the communication device 101, role information, and providing channel information. Note that the communication parameter includes a credential complying with the DPP standard, and a public key included in an authentication response from the communication device 102. Information included in the setting response is encrypted by a shared key generated between the communication devices 101 and 102. Then, communication parameter setting processing ends.

In step S306, the communication device 101 decides the priorities of the respective communication parameters that can be provided. The priority is the priority of trial order when the communication device 102 tries connection to a wireless network. Here, the communication device 101 decides priorities based on radio field intensities received from the respective access points 103 and 104. The radio field intensity is represented by the Received Signal Strength Indication (RSSI) value of a signal received from an access point. For example, if the radio field intensity of the access point 103 is higher than that of the access point 104, the priority of a communication parameter for connecting to the access point 103 is set to be higher than that of a communication parameter for connecting to the access point 104.

Generally, a configurator and an enrollee are close to each other, so a radio field intensity in the communication device 101 and that in the communication device 102 are substantially equal. Therefore, the radio field intensity is assumed to have a value measured by the communication device 101, but it may have a value measured by the communication device 102. In the latter case, the communication device 101 obtains in advance, from the communication device 102, a value measured by the communication device 102.

In step S307, the communication device 101 transmits, to the communication device 102 serving as an enrollee, a setting response including a plurality of communication parameters and information representing the priorities (priorities decided in step S306) of the respective communication parameters.

By the above-described processing, the communication device 101 serving as a configurator can transmit a setting response to the communication device 102 in a form in which the communication device 102 serving as an enrollee that receives a setting response can specify the priorities of respective communication parameters.

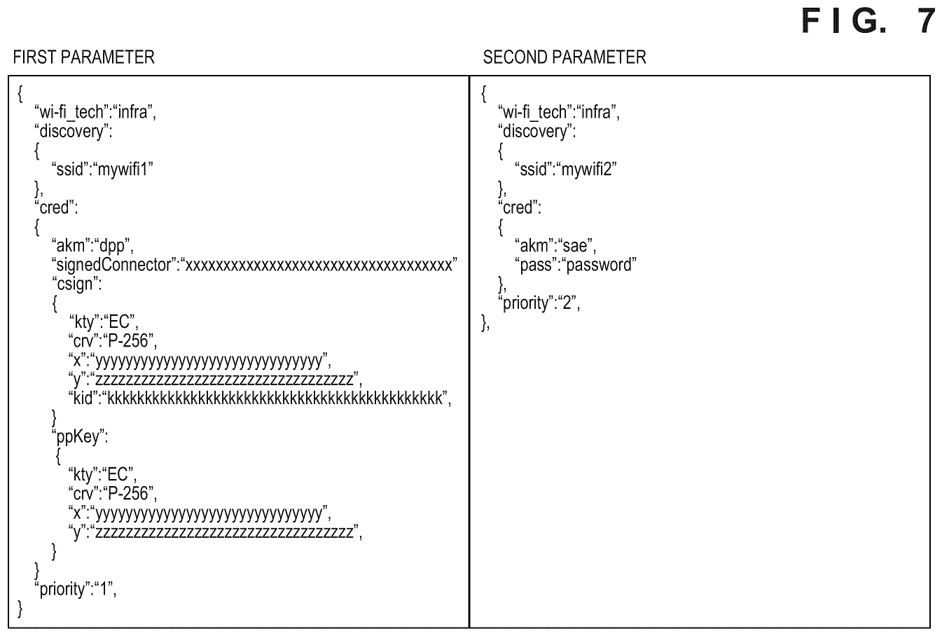

FIG. 7 is a view showing an example of a notification format representing priority. FIG. 7 shows an example of a DPP Configuration Object included in a setting response transmitted from a configurator to an enrollee. The DPP Configuration Object is described in the JaveScript Object Notation (JSON) form.

In FIG. 7, two communication parameters included in a setting response are exemplarily described. A “priority” field is added to the end in each communication parameter, and designates a character string or value representing priority.

A priority “1” is set for the first communication parameter, and a priority “2” is set for the second communication parameter. It is assumed here that a smaller set value represents a higher priority. Hence, the communication device 102 determines that the first communication parameter is higher in priority than the second communication parameter. This format can be used to represent the priorities of respective communication parameters.

Note that in this example, the “priority” field is set to represent priority, but the priority may be represented by another way. For example, the priority may be stored in another item within the DPP Configuration Object. For example, the priority may be stored in an optionally defined “Service” field. Instead of including information representing priority in the DPP Configuration Object, another object may be included in a setting response and announced. For example, an object describing information representing the descending order of priorities in a plurality of communication parameters may be included in a setting response. Note that, for example, an “index” field for identifying a DPP Configuration Object may be newly defined, and the information representing the descending order of priority may be information in which pieces of identification information are arranged in descending order of priority.

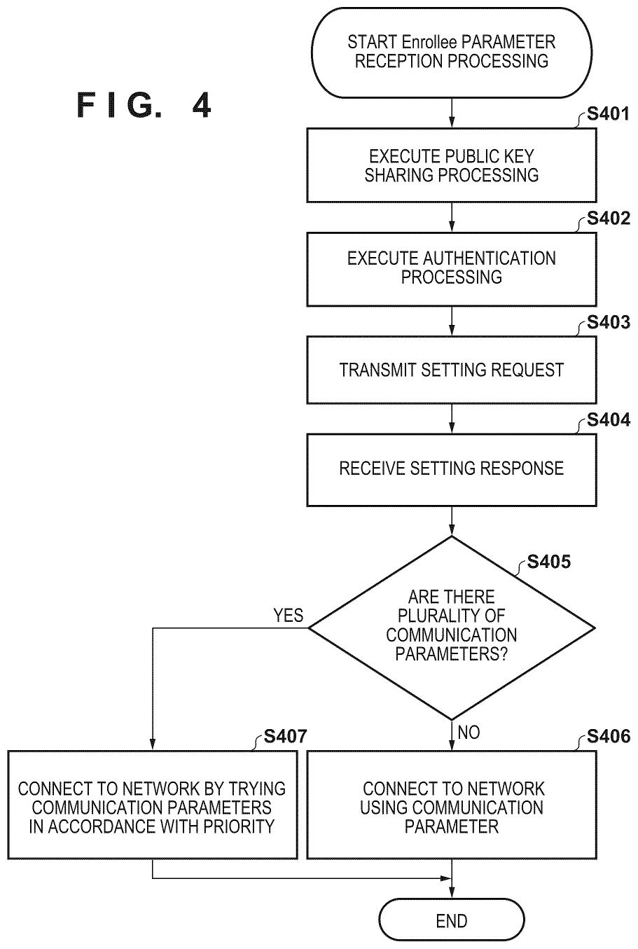

FIG. 4 is a flowchart of processing executed by the communication device 102 serving as an enrollee. The processing is implemented by, in a case where the communication device 102 is turned on, reading out a program stored in the storage unit 201 by the control unit 202 and executing it. Note that execution of the processing may be started by processing similar to that of the communication device 101 described with reference to FIG. 3, instead of the case where the communication device 102 is turned on.

In step S401, the communication device 102 performs authentication public key sharing processing. Here, the communication device 102 displays, on the output unit 205, a QR code including the authentication public key.

In step S402, the communication device 102 performs authentication processing. First, to perform authentication processing, the communication device 102 waits for an authentication request transmitted from the communication device 101. Note that in step S402, if the communication device 102 has not received an authentication request within a predetermined time after the start of waiting for an authentication request, communication parameter reception processing may end.

Upon receiving an authentication request, the communication device 102 performs verification processing of a device that has transmitted the authentication request. This determination is performed using authentication information included in the authentication request. That is, the communication device 102 calculates the hash value of the authentication public key of the communication device 102, compares the calculated hash value with a hash value (authentication information) included in the authentication request, and if these hash values coincide with each other, determines that the verification is successful.

If the verification is successful, the communication device 102 generates a shared key using both the public key of the communication device 101 for shared key generation and the private key of the communication device 102 for shared key generation by the same method as that used when the communication device 101 generates a shared key. Then, the communication device 102 transmits an authentication response. Note that if the verification fails, the communication device 102 does not transmit an authentication response. However, instead of this, if the verification fails, the communication device 102 may transmit an authentication response representing that the verification fails.

Upon transmitting the authentication response, the communication device 102 waits for an authentication confirmation transmitted from the communication device 101. Note that the time during which an authentication confirmation is awaited may be a predetermined time after transmitting an authentication response, or a predetermined time after the QR code is displayed in step S401.

Upon receiving an authentication confirmation, if tag information included in the authentication confirmation has correctly been decrypted by the shared key generated by the communication device 102, the communication device 102 determines that the authentication is successful. If the communication device 102 determines that the authentication is successful, it qualifies, as a configurator, the communication device 101 that has transmitted the authentication request. To the contrary, if the communication device 102 determines that the authentication is not successful (that is, the authentication fails), it does not qualify the communication device 101 as a configurator, and ends communication parameter reception processing.

In step S403, the communication device 102 transmits a setting request to the communication device 101 serving as a configurator. In step S404, the communication device 102 receives a setting response from the communication device 101 serving as a configurator.

In step S405, the communication device 102 determines whether there are a plurality of communication parameters in the received setting response. For example, if there are a plurality of DPP Configuration Objects, the communication device 102 determines that there are a plurality of communication parameters. Alternatively, if information representing priority is included, the communication device 102 determines that there are a plurality of communication parameters. If the communication device 102 determines that there are no plurality of communication parameters (there is only one communication parameter) (NO in step S405), the process advances to step S406. If the communication device 102 determines that there are a plurality of communication parameters (YES in step S405), the process advances to step S407.

In step S406, the communication device 102 performs connection to a wireless network using one obtained communication parameter. In contrast, in step S407, first, the communication device 102 specifies the priorities of the respective communication parameters. More specifically, information included in the setting response and representing priority is checked. Then, the communication device 102 tries connection to a wireless network in accordance with the priority.

Here, it is assumed that two communication parameters, that is, a communication parameter A for connection to the wireless network 105 and a communication parameter B for connection to the wireless network 106 are included. For example, if the priority of the communication parameter A is higher, first, connection to the wireless network 105 is tried using the communication parameter A. If connection to the wireless network 105 is completed, communication parameter setting processing ends. Note that when the communication parameter A is used but connection to the wireless network 105 fails, connection to the wireless network 106 is tried using the communication parameter B of the second highest priority.

By the processing described with reference to FIG. 4, the communication device 102 serving as an enrollee can specify the priorities of respective communication parameters and try connection to a wireless network in accordance with the priorities.

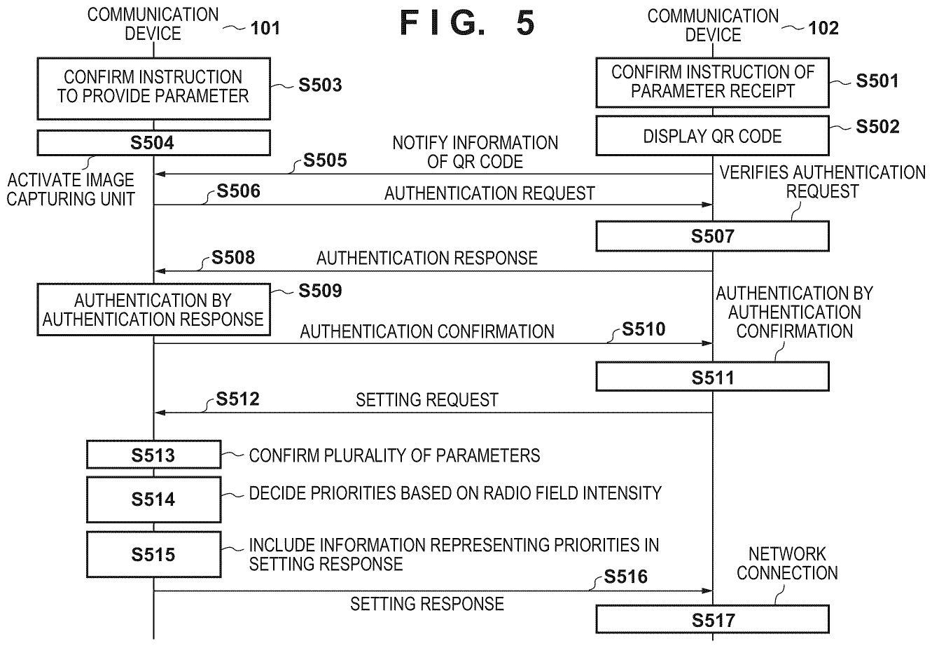

FIG. 5 is a sequence chart between the communication device 101 (configurator) and the communication device 102 (enrollee).

If the communication device 102 receives a priority reception instruction from a user (S501), it displays a QR code on the output unit 205 (S502), and waits for an authentication request. If the communication device 102 has not received an authentication request within a predetermined time, it may end waiting for an authentication request. Note that when the communication device 102 does not include a display or the like for displaying a QR code, and a QR code is printed on a label or the like attached to a housing or an accessory, S502 is skipped. That is, if the communication device 102 accepts a priority reception instruction (S501), it waits for an authentication request without performing processing in S502.

In contrast, if the communication device 101 receives a parameter transmission instruction from the user (S503), it activates the image capturing unit to capture an image of the QR code displayed by the communication device 102 (or printed on a label or the like) (S504). Then, the image capturing unit of the communication device 101 captures an image of the QR code, and the communication device 101 obtains information represented by the QR code (S505).

Upon obtaining the information represented by the QR code, the communication device 101 generates and transmits an authentication request, and the communication device 102 receives the authentication request (S506). The communication device 102 verifies the contents of the received authentication request (S507). If the communication device 102 determines that the communication device 101 which has transmitted the authentication request is a device which has captured an image of the QR code, it generates and transmits an authentication response (S508). Upon transmitting the authentication response to the communication device 101, the communication device 102 waits for an authentication confirmation transmitted from the communication device 101.

Upon receiving the authentication response, the communication device 101 verifies the contents of the authentication response (S509). If the communication device 101 determines that the verification is successful, it transmits an authentication confirmation to the communication device 102 (S510). Upon receiving the authentication confirmation from the communication device 101 in S510, the communication device 102 verifies the contents of the authentication confirmation (S511). If tag information has correctly been decrypted by a shared key generated by the communication device 102, the communication device 102 determines that the authentication is successful. If the communication device 102 determines that the authentication is successful, it transmits a setting request for requesting a communication parameter (S512). Upon transmitting the setting request, the communication device 102 waits for a setting response transmitted from the communication device 101.

Upon receiving the setting request, the communication device 101 confirms that there are a plurality of communication parameters which can be provided (S513). Then, the communication device 101 decides the priorities of the respective communication parameters in accordance with the radio field intensity of an access point (S514). The communication device 101 includes, in a setting response, information representing the priorities (S515). The communication device 101 transmits, to the communication device 102, a setting response including the information representing the priorities (S516).

Upon receiving the setting response, the communication device 102 tries connection to a wireless network based on the communication parameters and the information representing the priorities that are included in the setting response (S517).

As described above, according to the first embodiment, when transmitting a plurality of communication parameters, the communication device 101 serving as a configurator notifies the communication device 102 serving as an enrollee of information representing priority. In accordance with the priority, the communication device 102 can try connection to a wireless network. The communication device 102 can control to, for example, preferentially connect to a wireless network of a higher radio field intensity (that is, more stable connection). This can suppress degradation of the convenience of a user such as reattempt of communication setting.

### (Modification)

In the above description, the priority of a communication parameter is decided based on the radio field intensity, but is not limited to this. For example, the communication device 101 may decide the priorities of respective communication parameters in accordance with the security method of the communication parameter so that the communication device 102 controls to preferentially connect to a wireless network of higher security. More specifically, the priority may be decided based on the security level of the security method that is determined by an Authentication and Key Management Type (AKM) stored in a communication parameter. For example, the priority is set in the order of AKMs “dot1x”, “dpp”, “sae”, and “psk”.

Note that the priority is not limited to the order of security level, and the degree of priority may be decided in the order of security methods set for respective communication devices. When radio field intensities linked to respective communication parameters are equal (or within a predetermined range), the priority may be decided based on the security level.

The communication device 101 may decide the priorities of respective communication parameters in accordance with the date and time when configuration information is provided to an access point so that the communication device 102 controls to preferentially connect to a more lately formed wireless network. For example, the priority of a communication parameter corresponding to each access point is set to be high in descending order of the date and time when the configurator provides configuration information to the access point.

Further, the communication device 101 may decide the priorities of respective communication parameters in accordance with the expiration date included in the communication parameter so that the communication device 102 controls to preferentially connect to a wireless network connectable for a longer period. For example, the priority of a communication parameter may be decided in accordance with information representing an expiration date (for example, expiration date of AKM=dpp) included in a communication parameter. The priority of a communication parameter is set to be high in descending order of farness of the expiration date (duration of the term of validity).

In addition, the communication device 101 may decide the priorities of respective communication parameters in accordance with capability information representing the communication capability of the communication device 102 so that the communication device 102 controls to preferentially connect to a wireless network more suited to the communication capability of the communication device 102. For example, the capability information is an AKM supported by an enrollee. Here, the priority of a communication parameter having the same AKM as that supported by the enrollee is preferably set to be high. Note that when there are a plurality of supported AKMs, it may be decided to assign a higher priority to an AKM of higher security.

### Second Embodiment

In the second embodiment, a form in which when a plurality of communication parameters are included in a setting response, the communication parameters are announced without explicitly including, in the setting response, information representing priority will be explained. That is, the priority is specified by an enrollee without explicitly including, in the setting response, information representing priority. Note that the overall system configuration and the device configuration are similar to those in the first embodiment, so a description thereof will not be repeated.

### <Operation of Device>

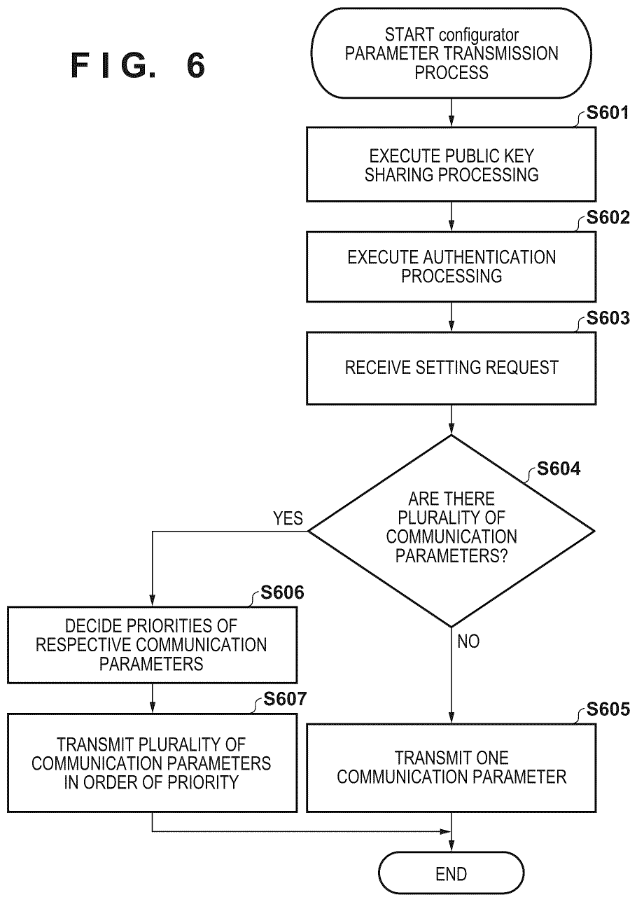

FIG. 6 is a flowchart of processing executed by a communication device (configurator) according to the second embodiment. Note that processes (steps S601 to S606) from authentication public key sharing processing up to decision of priority are similar to those in FIG. 3 (steps S301 to S306), and a description thereof will not be repeated. After a communication device 101 decides the priorities of respective communication parameters (step S606), the process advances to step S607.

In step S607, the communication device 101 includes, in a setting response, a plurality of communication parameters in the order of priority. More specifically, a plurality of DPP Configuration Objects in a predetermined storage area within the setting response are arranged from the start position of the predetermined storage area in descending order of priority. Then, the communication device 101 transmits the setting response to a communication device 102 serving as an enrollee.

When connecting to a wireless network, the communication device 102 performs connection to a wireless network by using, sequentially from the start, the plurality of DPP Configuration Objects stored in the predetermined storage area of the setting response.

As described above, according to the second embodiment, the communication device 101 serving as a configurator includes, in a setting response, a plurality of communication parameters in the order of priority. Thus, the priorities of respective communication parameters can be specified by an enrollee without explicitly including, in the setting response, information representing priority. This can suppress an increase in processing load for generating a setting response.

### (Modification)

In the above-described embodiments, a configuration in which information for setting a communication parameter is exchanged between devices using an image of a QR Code® has been explained. However, instead of image capturing of a QR Code®, wireless communication such as NFC or Bluetooth® may also be used. Alternatively, wireless communication such as IEEE 802.11ad or TransferJet® may also be used.

Note that a QR code read by the communication device 102 is not limited to a QR code displayed on the display unit. For example, an image of a QR code printed on a label or the like attached to the housing or accessory of the communication device 101 may be captured by the communication device 102. An image of a QR code recorded or displayed on the manual or package of the communication device 101 may also be captured. Further, not a QR code but a barcode, a two-dimensional code, or the like may be displayed. Information is not limited to image-encoded information such as a QR code, and may be information of a user-recognizable form (for example, character string).

In the above description, the communication device 101 displays a QR code (authentication public key), and the communication device 102 captures an image of the QR code, thereby sharing the authentication public key. However, it is also possible that the communication device 102 displays a QR code, and the communication device 101 captures an image of the QR code.

According to the present invention, it is possible to provide a communication parameter setting processing technique with high convenience of a user.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. A communication device comprising:
at least one memory that stores a set of instructions; and
at least one processor that executes the instructions, the instructions, when executed, causing the communication device to perform operations comprising:
receiving, from another communication device by wireless communication, a setting request to request provision of a communication parameter used for connection to a wireless network;
deciding priorities for respective communication parameters to be provided to the other communication device; and
transmitting, to the other communication device based on the decided priorities, a setting response to the setting request,
wherein the transmitted setting response includes the communication parameters in a form in which upon receiving the setting response, the other communication device can specify the priorities for the respective communication parameters.

2. The device according to claim 1, wherein the setting response includes information representing the priorities for the respective communication parameters.

3. The device according to claim 1, wherein the setting response includes information that associates each communication parameter constituting the communication parameters with a corresponding priority.

4. The device according to claim 1, wherein in the setting response, information representing a second communication parameter lower in priority than a first communication parameter is stored after information representing the first communication parameter of high priority.

5. The device according to claim 1, wherein the communication parameters are communication parameters for connecting to wireless networks formed by different access points complying with IEEE 802.11, and
in the deciding, priorities for the respective communication parameters are decided based on radio field intensities of respective wireless networks corresponding to the communication parameters.

6. The device according to claim 1, wherein in the deciding, priorities for the respective communication parameters are decided based on security methods of the respective communication parameters.

7. The device according to claim 1, wherein the communication parameters are communication parameters for connecting to wireless networks formed by different access points of the Institute of Electrical and Electronics Engineers (IEEE) 802.11 series standard, and
in the deciding, priorities for the respective communication parameters are decided based on dates and times when configuration information is provided to respective access points corresponding to the communication parameters.

8. The device according to claim 1, wherein in the deciding, priorities for the respective communication parameters are decided based on expiration dates of the respective communication parameters.

9. The device according to claim 1, wherein the operations further comprise obtaining capability information about a communication capability of the other communication device, and
in the deciding, priorities for the respective communication parameters are decided based on the obtained communication capability of the other communication device.

10. The device according to claim 1, wherein the communication device performs communication complying with the Institute of Electrical and Electronics Engineers (IEEE) 802.11 series standard,
the setting request is a DPP_Configuration_Request frame complying with the Device Provisioning Protocol (DPP) standard of version 2.0 or subsequent version, and
the setting response is a DPP_Configuration_Response frame complying with the DPP standard of version 2.0 or subsequent version.

11. A control method of a communication device, comprising:
receiving, from another communication device by wireless communication, a setting request to request provision of a communication parameter used for connection to a wireless network;
deciding priorities for respective communication parameters to be provided to the other communication device; and
transmitting, to the other communication device based on the decided priorities, a setting response to the setting request,
wherein the transmitted setting response includes the communication parameters in a form in which upon receiving the setting response, the other communication device can specify the priorities for the respective communication parameters.

12. A control method of a communication system including a first communication device and a second communication device, the method comprising:
causing the first communication device to transmit, to the second communication device via wireless communication, a setting request to request provision of a communication parameter for connection to a wireless network;
causing the second communication device to receive the setting request from the first communication device by wireless communication;
causing the second communication device to decide priorities for respective communication parameters to be provided to the first communication device;
causing the second communication device to transmit a setting response to the first communication device based on the decided priorities;
causing the first communication device to receive, from the second communication device, the setting response to the setting request; and
causing the first communication device to try connection to a wireless network based on communication parameters included in the setting response,
wherein the setting response transmitted from the second communication device includes the communication parameters in a form in which upon receiving the setting response, the first communication device can specify the priorities for the respective communication parameters, and
in the try connection to a wireless network in the first communication device, connection to the wireless network is tried using the communication parameters in descending order of the priorities for the respective communication parameters out of the communication parameters included in the setting response.
